(19) United States
(12) Patent Application Publication
(10) Pub. No.: US 2003/0097253 A1
(43) Pub. Date: May 22, 2003

(54) Device to edit a text in predefined windows

(75) Inventor: Dieter Hoi, Guntramsdorf (AT)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 10/294,016

(22) Filed: Nov. 12, 2002

(30) Foreign Application Priority Data
Nov. 16, 2001 (EP) 01 000 639.3

(51) Int. Cl. G06F 17/27; G10L 13/08

(52) U.S. Cl. 704/9; 704/260

(57) ABSTRACT

A user of a transcription device (1) can output a spoken text (GT) with associated marking information (MI) to the transcription device (1). The transcription device (1) performs an automatic transcription of the spoken text (GT) into a recognized text (ET) and assigns parts of the recognized text (ET) to display windows (D1, D2, D3) in accordance with the marking information (MI). The parts of the recognized texts (ET) are displayed in the display windows (D1, D2, D3) identified by the marking information (MI), with the corresponding display window (D1, D2, D3) being activated at the correct time during the acoustic reproduction of the spoken text (GT).

The invention relates to a transcription device for the transcription of a spoken text into a recognized text and for editing the recognized text.

The invention further relates to an editing device for editing a text recognized by a transcription device.

The invention further relates to an editing process for editing a text recognized during the execution of a transcription process.

The invention further relates to a computer program product which may be loaded directly into the internal memory of a digital computer and comprises software code sections.

A transcription device of this kind, an editing device of this kind, an editing process of this kind, and a computer program product of this kind are known from the document U.S. Pat. No. 5,267,155, in which a so-called “online” dictation device is disclosed. The known dictation device is formed by a computer which executes voice recognition software and text processing software. A user of the known dictation device may dictate a spoken text into a microphone connected to the computer. The voice recognition software forming transcription means executes a voice recognition process and in doing so assigns a recognized word to each spoken word of the spoken text, thereby obtaining recognized text for the spoken text.

The computer which executes the text processing software computer forms an editing device and stores the recognized text and facilitates the editing or correction of the recognized text. A monitor is connected to the computer, and editing means in the editing device facilitate the display of texts in several display windows shown on the monitor simultaneously. Here, a first display window shows a standard text and a second display window shows words which may be inserted in the standard text.

The user of the known dictation device can position a text cursor in the first display window forming an input window at a specific position in the standard text and speak one of the insertable words shown in the second display window into the microphone. The spoken word is recognized by the transcription means and the recognized word is inserted into the standard text at the position of the text cursor. This facilitates the simple generation of standard letters, which may be adapted by the user for the individual case in question by means of spoken words.

The known transcription device also facilitates the completion of forms with the aid of spoken commands and spoken texts. For this, the editing means displays the form to be completed in a display window and the user may speak into a microphone firstly a command to mark the field in the form and then the text to be entered into this marked field of the form.

It has been found to be a drawback with the known transcription device that a user always has to activate the display window in which the text recognized by the transcription device is to be displayed. Another drawback identified is that the user does not receive any support from the editing device when editing the text recognized by the transcription device.

It is an object of the invention to create a transcription device of the type specified in the first paragraph, an editing device of the type specified in the second paragraph, an editing process of the type described in the third paragraph, and a computer program product of the type described in the fourth paragraph in which the aforesaid drawbacks are avoided.

To achieve the aforesaid object, a transcription device of this kind is provided with features according to the invention so that the transcription device may be characterized in the way described in the following.

A transcription device for the transcription of a spoken text into a recognized text and for editing the recognized text, with

reception means for the reception of the spoken text together with associated marking information which assignsparts of the spoken text to specific display windows, and with

transcription means for transcribing the spoken text and for outputting the associated recognized text, and with

storage means for storing the spoken text, the marking information, and the recognized text, and with

editing means for editing the recognized text such that it is possible to display the recognized text visually in at least two display windows in accordance with the associated marking information.

To achieve the aforesaid object, an editing device of this type is provided with features according to the invention, so that the editing device may be characterized in the way described in the following.

An editing device for editing a text recognized by a transcription device with

reception means for receiving a spoken text together with associated marking information which assignsparts of the spoken text to specific display windows, and for receiving a text recognized by the transcription device for the spoken text, and with

storage means for storing the spoken text, the marking information, and the recognized text, and with

editing means for editing the recognized text such that it is possible to display the recognized text visually in at least two display windows in accordance with the associated marking information.

To achieve the aforesaid object, an editing process of this kind is provided with features according to the invention, so that the editing process may be characterized in the way described in the following.

An editing process for editing a text recognized during the execution of a transcription process with the following steps being executed:

reception of a spoken text together with associated marking information which assigns parts of the spoken text to specific display windows;

reception of a recognized text for the spoken text during the transcription process;

storage of the spoken text, the marking information, and the recognized text;

editing of the recognized text, such that it is possible to display the recognized text visually in at least two display windows in accordance with the associated marking information.

To achieve the aforesaid object, a computer program product of this type is provided with features according to the invention, so that the computer program product may be characterized in the way described in the following.

A computer program product which may be loaded directly into the internal memory of a digital computer and which comprises software code sections such that the computer executes the steps of the process in accordance with claim 10 when the product is running on the computer.

The features according to the invention enable an author of a dictation or the spoken text to assign these parts of the spoken text to specific display windows, in which the associated recognized text is to be displayed after the automatic transcription by the transcription device, during the dictation already. This is particularly advantageous with a so-called “offline” transcription device to which the author transmits the dictation and by which the automatic transcription is first performed. Following this, the text automatically recognized by the transcription device is manually edited by a corrector with the aid of the editing device.

Therefore, advantageously, the corrector does not have to worry about distributing the recognized text over display windows. Usually, each part of the recognized text shown in a display window is also stored in an individual computer file. These parts of the recognized text stored in separate computer files may subsequently be subjected to different types of processing, which is also advantageous.

The measures in claim 2, in claim 8, and in claim 11 achieve the advantage that during the acoustic reproduction of the spoken text stored in the storage means, to support the manual correction by the corrector, the display window is automatically activated as an input window containing the recognized text for the spoken text which has just been acoustically reproduced. This means that the corrector can concentrate on the correction of the recognized text and does not first need to activate the associated display window for a correction to the recognized text.

If the parts of the recognized text are displayed in several display windows, it may occur that not all display windows are visible simultaneously. In addition, it may be desirable always only to display one display window on the monitor. The measures in claim 3, in claim 9, and in claim 12 achieve the advantage that the display of the display window containing the recognized text for that spoken text that has just been reproduced is automatically activated. In this way, there is an advantageous automatic switch between the display windows containing the recognized text during the acoustic reproduction of the spoken text.

The measures in claim 4 achieve the advantage that they permit a synchronous type of reproduction to support the corrector during the correction of the recognized text.

The measures in claim 5 achieve the advantage that the link information transmitted by the transcription device for the synchronous type of reproduction is used as marking information, and the display windows corresponding to the link information for the spoken text which has just been acoustically reproduced are activated.

The author of the spoken text could use a button on the microphone or a button on his dictation device to enter marking information to mark parts of the spoken text. The measures in claim 6 achieve the advantage that the author can enter the marking information in the form of spoken commands. This greatly simplifies the entry of the marking information, and the author's microphone and dictation device do not have to provide input possibilities.

The invention will be further described with reference to embodiments shown in the drawings to which, however, the invention is not restricted.

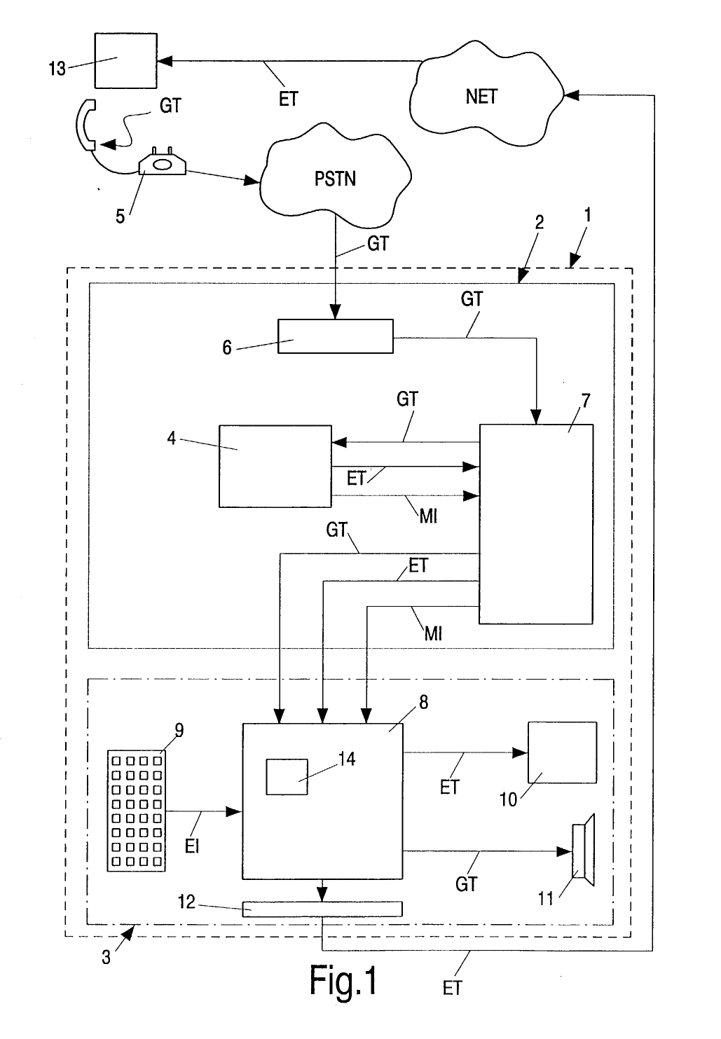

FIG. 1 shows a transcription device for the transcription of a spoken text into a recognized text, with the parts of the recognized text being displayed in three different display windows.

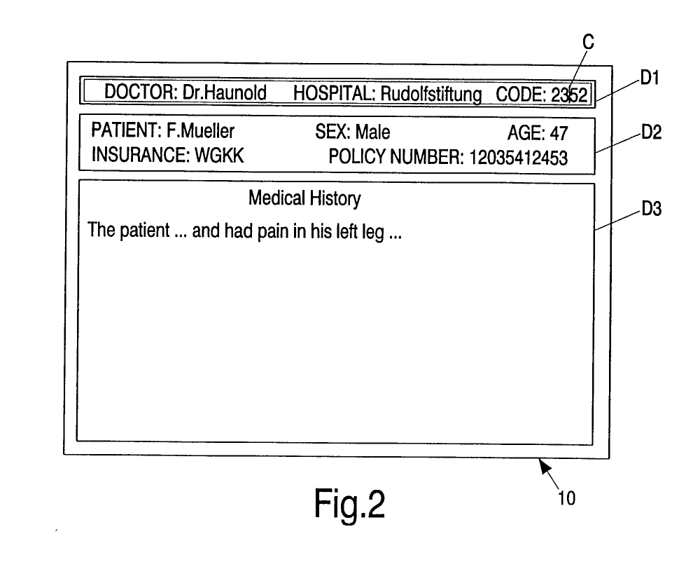

FIG. 2 shows the recognized text displayed on a monitor in three different display windows.

FIG. 1 shows a transcription device 1 for the transcription of a spoken text GT into a recognized text ET and for editing incorrectly recognized text parts of the recognized text ET. The transcription device 1 facilitates a transcription service with which doctors from several hospitals may dictate medical histories as the spoken text GT with the aid of their telephones in order to obtain a written medical history as the recognized text ET by post or email from the transcription device 1. The operators of the hospitals will pay the operator of the transcription service for the use of the transcription service. Transcription services of this kind are widely used particularly in America and save the hospitals a large number of typists.

The transcription device 1 is formed by a first computer 2 and a large number of second computers 3, of which second computers 3, however, only one is shown in FIG. 1. The first computer 2 executes voice recognition software and in doing so forms transcription means 4. The transcription means 4 are designed for the transcription of a spoken text GT received from a telephone 5 via a telephone network PSTN into a recognized text ET. Voice recognition software of this type has been known for a long time and was, for example, marketed by the applicant under the name “Speech Magic™” and therefore will not be dealt with in any more detail here.

The first computer 2 also has a telephone interface 6. The telephone interface 6 forms reception means for the reception of the spoken text GT, which according to the invention also contains associated marking information MI. The marking information MI assigns parts of the spoken text GT to specific display windows D, which will be described in further detail with reference to FIG. 2.

The first computer 2 also has storage means 7 for storing the received spoken text GT, the marking information MI, and the text ET recognized by the transcription means 4. The storage means 7 are formed from a RAM (random access memory) and from a hard disk in the first computer 2.

Correctors in the transcription services edit or correct the text ET recognized by the transcription means 4. Each one of these correctors has access to one of these second computers 3, which forms an editing device for editing the recognized text ET. The second computer 3 executes text processing software—such as, for example, “Word for Windows®”—and in doing so forms editing means 8. Connected to the second computer 3 are a keyboard 9, a monitor 10, a loudspeaker 11, and a data modem 12. A text ET recognized by the transcription means 4 and edited with the editing means 8 may be transmitted by the editing means 8 via the data modem 12 and a data network NET to a third computer 13 belonging to the doctor in the hospital in the form of an email. This will be described in further detail with reference to the following example of an application of the transcription device 1.

For the purposes of the example of an application, it is assumed that a doctor “Dr. Haunold” from the hospital “Rudolfstiftung” dictates the medical history of a patient “F. Mueller” in order to obtain a written medical history. In addition, at the same time all the data required for arrangement payment for the transcription services with the operator of the transcription services and for arranging payment for the medical services with the medical insurance scheme are to be entered into the relevant databases.

In order to use the transcription service, the doctor uses the telephone 5 to dial the telephone number of the transcription device 1 and identifies himself to the transcription device 1. To do this he says the words “Doctor's Data” and then states his name “Dr. Haunold”, his hospital “Rudolfstiftung” and a code number assigned to him “2352”.

Then, the doctor dictates the patient's data. To do this he says the words “Patient '5 Data” and “F. Mueller . . . male . . . forty seven . . . WGKK . . . onetwo . . . three”. Then, he starts to dictate the medical history. To do this, he says the words “Medical History” and “The patient . . . and had pain in his left leg . . . ”. Here, the spoken words “Doctor's Data”, “Patient's Data” and “Medical History” form marking information MI for the assignment of parts of the spoken text GT to display windows, which will be described in more detail below.

The telephone 5 will transmit a telephone signal via the telephone network PSTN to the telephone interface 6 containing the spoken text GT dictated by the doctor “Dr. Haunold”. The digital data containing the spoken text GT are then stored by the telephone interface 6 in the storage means 7.

The transcription means 4 then determine the recognized text ET assigned to the stored spoken text GT during the execution of the voice recognition software and store it in the storage means 7. In addition, the transcription means 4 are designed to recognize the spoken commands in the spoken text GT and to generate the marking information MI, which assigns the subsequent spoken text GT in the dictation to a display window. The marking information MI is also stored in the storage means 7.

If a corrector starts to correct or edit the recognized text ET in the dictation by the doctor “Dr. Haunold” and accordingly uses the keyboard 9 to activate the second computer 3, the monitor 10 displaying the image shown in FIG. 2. The part of the recognized text identified by the marking information MI=“Doctor's Data” is inserted by the editing means 8 into a form in a first display window D1. This is possible because when making his dictation the doctor adhered to the sequence of the data to be entered into the form. The part of the recognized text identified by the marking information MI=“Patient's Data” is entered into a form in a second display window D2, and the part of the recognized text identified by the marking information MI=“medical history” is inserted in a text field in a third display window D3.

This achieves the advantage that the corrector did not have to divide the text ET recognized by the transcription means 4 into parts and assign them to the individual display windows D1 to D3 by means of “Copy” and “Insert” manually. Another advantage achieved is that, owing to the marking information MI, parts of the recognized text ET assigned to a display window were also stored in their own files. The fact that this does not have to be the case, however, is also particularly advantageous in this application, because the data for the calculating the accounts with the operator of the transcription services and the medical insurance scheme have to be processed differently.

The editing means 8 are designed to output the spoken text GT read out from the storage means 7 to the loudspeaker 11 for the acoustic reproduction of the spoken text. The editing means 8 now have activation means 14 which are designed to activate the display of the display window during the acoustic reproduction of the spoken text GT, the display window being identified by the marking information MI assigned to the spoken text GT which has just been acoustically reproduced.

This is in particular advantageous if it is not possible to display all display windows simultaneously on the monitor 10. For example, the third display window D3 could be displayed on the entire monitor 10 in order to enable a larger part of the medical history to be viewed at once. If the spoken text GT stored in the storage means 7 for which the associated recognized Text ET is displayed in the first display window D1 is acoustically reproduced, then in accordance with the invention, the display of the first display window D1 is activated and hence the first display window D1 displayed in front of the third display window D3. This enables the corrector to listen to the spoken text GT and the relevant display windows D1 to D3 are activated at the correct time and shown in the foreground.

The activation means 14 are also designed to activate the relevant display window assigned by the marking information MI as an input window for editing the recognized text ET during the acoustic reproduction of the spoken text GT. This achieves the advantage that, if the corrector recognizes an error in the recognized text ET or would like to make other changes to the recognized text ET, the display window for which he/she is currently listening to the associated spoken text GT is already activated as an input window.

It may be mentioned that a display window is activated as an input window if a text cursor C is positioned and displayed therein. The text cursor C indicates the position in the recognized text ET at which a text entry by the corrector would be entered with the keyboard 9. As shown in FIG. 2, the first display window has a double frame and is hence identified to the corrector as the active display window and input window.

The transcription means 4 are furthermore designed to determine link information during the transcription, said link information identifying the associated recognized text ET for each part of the spoken text GT. In addition, with the synchronous type of reproduction activated in the transcription device 1, the editing means 8 are designed for the acoustic reproduction of the spoken text GT and for the synchronous visual marking of the associated recognized text ET identified by the link information.

This achieves the advantage that during the acoustic reproduction of the spoken text GT the relevant recognized word for the reproduced spoken word is visually marked, and in addition the active display window is changed at the correct time. The corrector can therefore advantageously concentrate particularly well on the content of the recognized text ET to be corrected.

If the text ET recognized by the transcription means 4 corresponding to the marking information MI has already been assigned display windows or files by the editing means 8, then during the synchronous type of reproduction, the display window may also be activated at the correct time by means of the link information. Therefore, in this case, the link information also forms marking information for the activation of display windows.

A user of the transcription device 1 can enter marking information MI in many different ways. For example, he could actuate a button on the keypad of the telephone 5 at the beginning and/or end of each part of the spoken text GT to be assigned to a display window. The user could also record the dictation in advance with a dictation device and use a marking button on the dictation device to enter marking information MI. However, it is particularly advantageous -as explained with reference to the application-example- to enter marking information MI for marking parts of the spoken text GT by spoken commands contained in the spoken text GT.

It may be mentioned that the transcription device 1 could also be formed by a computer which executes voice recognition software and text processing software. This one computer could, for example, be formed by a server connected to the Internet.

Similarly, the division of the parts of the recognized text ET into files according to the invention in accordance with the user's marking information MI may be performed by the transcription means 4. In this case, the editing means 8 would display parts of the recognized text in separate files in separate display windows, such as is the case, for example, with Windows® programs.

It may be mentioned that the measures according to the invention, in particular with so-called “offline” transcription devices—as described with reference to the application example—are advantageous. However, it is also possible to provide these measures with a so-called “online” transcription device, with which the words spoken by a user are directly transcribed by transcription means and displayed on a monitor.

It may be mentioned that a computer program product in accordance with the invention, which is executed by the computer, may be stored on an optically or magnetically readable data carrier.

It may be mentioned that an editing device in accordance with the invention may alternatively be designed for the manual typist of a spoken text together with the associated marking information. In this case, a typist would listen to the spoken text and write it manually with the aid of the computer keyboard. In accordance with the invention, activation means would activate the associated display window as an input window in accordance with the marking information assigned to the spoken text at the correct time and position the text cursor in the input window. This achieves the advantage that the typist only has to concentrate on entering the text and not on changing the input window.

It may be mentioned that the spoken text and the marking information may also be received by a digital dictation device as digital data via a data modem in the transcription device.

1. A transcription device (1) for the transcription of a spoken text (GT) into a recognized text (ET) and for editing the recognized text (ET), with
reception means (6) for receiving the spoken text (GT) together with associated marking information (MI) which assigns parts of the spoken text (GT) to specific display windows (D1, D2, D3), and with
transcription means (4) for transcribing the spoken text (GT) and for outputting the associated recognized text (ET), and with
storage means (7) for storing the spoken text (GT), the marking information (MI), and the recognized text (ET), and with
editing means (8) for editing the recognized text (ET), such that it is possible to display the recognized Text (ET) visually in at least two display windows (D1, D2, D3) in accordance with the associated marking information (MI).

2. A transcription device (1) as claimed in claim 1, wherein it is possible to reproduce the spoken text (GT) acoustically, and activation means (14) are provided which are designed to activate the display window (D1, D2, D3) as an input window for editing the recognized text (ET) during the acoustic reproduction of the spoken text (GT), said display window (D1, D2, D3) being identified by the marking information (MI) assigned to the spoken text (GT) which has just been acoustically reproduced.

3. A transcription device (1) as claimed in claim 1, wherein activation means (14) are provided which are designed to activate the display of the display window (D1, D2, D3) during the acoustic reproduction of the spoken text (GT), said display window (D1, D2, D3) being identified by the marking information (MI) assigned to the spoken text (GT) which has just been acoustically reproduced.

4. A transcription device (1) as claimed in claim 1, wherein the transcription means (4) are designed to determine link information during transcription, said link information identifying the associated recognized text (ET) for every part of the spoken text (GT), and wherein, with the synchronous type of reproduction activated in the transcription device (1), the editing means (8) are designed for the acoustic reproduction of the spoken text (GT) and for the synchronous visual marking of the associated recognized text (ET) identified by the link information.

5. A transcription device (1) as claimed in claim 4, wherein activation means (14) are provided which are designed to activate the display window (D1, D2, D3) as an input window for editing the recognized text (ET) during the acoustic reproduction of the spoken text (GT), said display window (D1, D2, D3) being identified by the link information assigned to the spoken text (GT) which has just been acoustically reproduced.

6. A transcription device (1) as claimed in claim 1, wherein the marking information (MI) is formed by a spoken command which is contained in the spoken text (GT) at the beginning and/or the end of a respective part of the spoken text (GT) assigned to a display window (D1, D2, D3).

7. An editing device (3) for editing a text (ET) recognized by a transcription device (1) with
reception means for receiving a spoken text (GT) together with the associated marking information (MI) which assigns parts of the spoken text (GT) to specific display windows (D1, D2, D3), and for receiving a text (ET) recognized by the transcription device (1) for the spoken text (GT), and with
storage means for storing the spoken text (GT), the marking information (MI), and the recognized text (ET), and with
editing means (8) for editing the recognized text (ET), such that it is possible to display visually the recognized text (ET) in at least two display windows (D1, D2, D3) in accordance with the associated marking information (MI).

8. An editing device (3) as claimed in claim 7, wherin it is possible to acoustically reproduce the spoken text (GT), and activation means (14) are provided which are designed for the activation of the display window (D1, D2, D3) as an input window for editing the recognized text (ET) during the acoustic reproduction of the spoken text (GT), said display window (D1, D2, D3) being identified by the marking information (MI) assigned to the spoken text (GT) which has just been acoustically reproduced.

9. An editing device (3) as claimed in claim 7, wherein activation means (14) are provided which are designed to activate the display of the display window (D1, D2, D3) during the acoustic reproduction of the spoken text (GT), said display window (D1, D2, D3) being identified by the marking information (MI) assigned to the spoken text (GT) which has just been acoustically reproduced.

10. An editing process for editing a recognized text (ET) during the execution of an transcription process wherein the following steps are executed:
reception of a spoken text (GT) together with associated marking information (MI), which assigns parts of the spoken text (GT) to specific display windows (D1, D2, D3);
reception of a recognized text (ET) for the spoken text (GT) during the transcription process;
storage of the spoken text (GT), the marking information (MI), and the recognized text (ET);
editing of the recognized text (ET), such that it is possible to display the recognized text (ET) visually in at least two display windows (D1, D2, D3) in accordance with the associated marking information (MI).

11. An editing process as claimed in claim 10, wherein the following further step is executed: acoustic reproduction of the spoken text (GT) wherein the display window (D1, D2, D3) is activated as an input window for editing the recognized text (ET) during the acoustic reproduction of the spoken text (GT) said display window (D1, D2, D3) being identified by the marking information assigned to the spoken text (GT) which has just been acoustically reproduced.

12. An editing process as claimed in claim 10, with the following further step being executed:, display of the display window (D1, D2, D3) is activated during the acoustic reproduction of the spoken text (GT), said display window (D1, D2, D3) being identified by the marking information (MI) assigned to the spoken text (GT) which has just been acoustically reproduced.

13. A computer program product which may be loaded directly into the internal memory of a digital computer (1) and contains software code sections, wherein the computer (1) executes the steps of the procedure as claimed in claim 10 when the product is run on the computer (1).

14. A computer program product as claimed in claim 13, said product being stored on a computer-readable medium.
